(19) United States
(12) Patent Application Publication
(10) Pub. No.: US 2021/0149244 A1
(43) Pub. Date: May 20, 2021

(54) PREPARATION PROCESS OF COLOR FILM SUBSTRATE, COLOR FILM SUBSTRATE THEREOF, AND DISPLAY DEVICE

(71) Applicant: HKC CORPORATION LIMITED, Shenzhen, Guangdong (CN)

(72) Inventor: Lei ZHANG, Shenzhen, Guangdong (CN)

(21) Appl. No.: 17/044,725

(22) PCT Filed: Dec. 19, 2018
(86) PCT No.: PCT/CN2018/121902

§ 371 Date: Oct. 1, 2020

(30) Foreign Application Priority Data
Dec. 4, 2018 (CN) 201811478019.1

(51) Int. Cl. G02F 1/1335; G02F 1/1339

(52) U.S. Cl. CPC G02F 1/133516; G02F 1/13394; G02F 1/133512

(57) ABSTRACT

The present disclosure provides a preparation process of a color film substrate, a color film substrate prepared by the preparation process of the color film substrate, and a display device having the color film substrate. The preparation process of a color film substrate includes the following steps: Forming a transparent conductive thin film on a substrate board by a sputtering process and forming a black matrix by a coating operation; coating a color resist on the transparent conductive thin film or the black matrix to form pixel units.

### CROSS-REFERENCE TO RELATED APPLICATIONS

The present application is the National Stage of International Application with No. PCT/CN2018/121902, filed on Dec. 19, 2018, which claims the benefit of Chinese Patent Application with No. 201811478019.1, filed on Dec. 4, 2018 and entitled “Preparation Process of Color Film Substrate, Color Film Substrate thereof, and Display Device”, the entirety of which is incorporated herein by reference.

### FIELD

The present disclosure relates to the field of displays, and in particular, to a preparation process of a color film substrate, a color film substrate prepared by the preparation process of the color film substrate, and a display device having the color film substrate.

### BACKGROUND

Liquid crystal displays are widely used in a variety of electrical devices, such as televisions and computer screens. Color film substrates are a key part for colorization in the liquid crystal displays, the cost of which is the highest among the parts therein. At present, the color film substrates need to suffer a thermal process, for instance a printing process for printing an alignment film (temperature up to 90° C.), after a transparent conductive thin film process being finished. Due to the presence of moisture in the color resist before entering the thermal process, bubbles appear in the finished products of the liquid crystal displays, which is induced by the evaporation of the moisture from the color resist caused by high temperature during the thermal process, thereby the display effect is affected.

### SUMMARY

The main purpose of the present disclosure is to provide a preparation process of a color film substrate, aiming at avoiding bubbles in the finished products of the display devices, and negative effect to display.

In order to achieve the above purpose, the present disclosure provides a preparation process of a color film substrate including: forming a transparent conductive thin film on a substrate board by a sputtering process and forming a black matrix by a coating operation; and coating a color resist on the transparent conductive thin film or the black matrix to form pixel units.

Optionally, the step of forming the transparent conductive thin film on the substrate board by the sputtering process and forming the black matrix by the coating operation includes: forming the transparent conductive thin film on the substrate board by the sputtering process; and forming the black matrix on the transparent conductive thin film by the coating operation.

Optionally, the step of forming the transparent conductive thin film on the substrate board by the sputtering process and forming the black matrix by the coating operation includes: forming the black matrix on the substrate board by the coating operation; and forming the transparent conductive thin film on the black matrix by the sputtering process.

The present disclosure further provides a color film substrate, and the color film substrate is located on a light emitting side of a liquid crystal layer in a display device. The color film substrate includes: a substrate board, a transparent conductive thin film, and a color resist. The transparent conductive thin film and the color resist are disposed on the substrate board, and the transparent conductive thin film is located between the substrate board and the color resist, and the transparent conductive thin film at least covers a region enclosed by the color resist.

Optionally, the color film substrate further includes a black matrix located between the transparent conductive thin film and the color resist, and the color resist is coated on the black matrix.

Optionally, the color resist includes color resists of three primary colors of red, green, and blue.

Optionally, the color resist includes color resists of four primary colors of red, green, blue, and yellow.

Optionally, the color resist includes color resists of four primary colors of red, green, blue, and white.

Optionally, the color resists of the three primary colors of red, green, and blue are sequentially arranged and spaced apart from each other.

Optionally, the color film substrate further includes a black matrix located between the transparent conductive thin film and the substrate board, and the color resist is coated on the transparent conductive thin film.

Optionally, the color resist includes color resists of three primary colors of red, green, and blue, or the color resist includes color resists of four primary colors of red, green, blue, and yellow, or the color resist includes color resists of four primary colors of red, green, blue and white.

Optionally, the color resists are spaced apart from each other, and the black matrix is coated among the spaced color resists.

Optionally, edges of the color resist overlap with the black matrix.

Optionally, the color resist does not completely overlap with the black matrix.

Optionally, the transparent conductive thin film is formed of Indium Tin Oxide.

Optionally, the outermost color resist is surrounded by the black matrix.

Optionally, the substrate is transparent and is transmitable to visible light.

The present disclosure further provides a display device, and the display device includes a color film substrate, and the color film substrate is located on a light emitting side of a liquid crystal layer in the display device. The color film substrate includes: a substrate board, a transparent conductive thin film, and a color resist. The transparent conductive thin film and the color resist are disposed on the substrate board, and the transparent conductive thin film is located between the substrate board and the color resist, and the transparent conductive thin film at least covers a region enclosed by the color resist.

Optionally, the display device further includes an array substrate, and the liquid crystal is located between the array substrate and the color film substrate. Light is transmitted from one side of the array substrate to the color film substrate through the liquid crystal and is transmitted out of the color film substrate through the color resist.

Optionally, the color film substrate further includes a spacer disposed on a main body of the color film substrate.

According to the disclosed technical solution, the transparent conductive thin film is sputtered between the substrate board and the color resist, making the transparent conductive thin film be located between the substrate board and the color resist, instead of covering on the surface of the color film substrate, so that the release of moisture in the color resist shall not be obstructed after entering the subsequent thermal process, thereby bubbles formed by the unreleased moisture won't appear in the finished products of the color film substrates.

### BRIEF DESCRIPTION OF THE DRAWINGS

In order to more clearly illustrate the technical solutions of the embodiments of the present disclosure, the drawings used in the description of the embodiments will be briefly described below. It is obvious that the drawings in the following description are only some embodiments of the present disclosure, and those skilled in the art can obtain other drawings according to the structures shown in the drawings without any creative work.

FIG. 1 is a schematic flow chart of a preparation process of a color film substrate according to the present disclosure;

FIG. 2 is a schematic flow chart of step S10 in FIG. 1 according to an embodiment;

FIG. 3 is a schematic flow chart of step S10 in FIG. 1 according to another embodiment;

FIG. 4 is a schematic structural view of the color film substrate according to an embodiment of the present disclosure;

FIG. 5 is a schematic structural view of the color film substrate according to another embodiment of the present disclosure;

FIG. 6 is a schematic structural view of a display device according to an embodiment of the present disclosure.

The implementation, functional features and advantages of the present disclosure will be described in conjunction with the embodiments with reference to the accompanying drawings.

### DETAILED DESCRIPTION OF THE EMBODIMENTS

The technical solutions in the embodiments of the present disclosure are clearly and completely described in the following with reference to the accompanying drawings in the embodiments of the present disclosure. It is obvious that the described embodiments are only a part of the embodiments of the present disclosure, and not all of the embodiments. All other embodiments obtained by those of ordinary skill in the art without creative labor based on the embodiments here are within the scope of protection in the present disclosure.

It should be noted that all directional indications (such as up, down, left, right, front, back, . . . ) in the embodiments of the present disclosure are only used to explain relative positional relationship, motion situation, etc. between components in a certain posture (as shown in the drawing). If the specific posture changes, the directional indication also changes accordingly.

In addition, the descriptions of “first”, “second”, and the like in the present disclosure are used for the purpose of description only, and are not to be construed as indicating or implying their relative importance or implicitly indicating the number of technical features indicated. Thus, features defining “first” or “second” may include at least one of the features, either explicitly or implicitly. In addition, the technical solutions between the various embodiments may be combined with each other, but must be based on the realization of those skilled in the art, and when the combination of the technical solutions is contradictory or impossible to implement, it should be considered that the combination of the technical solutions does not exist, nor is it within the scope of protection required by this disclosure.

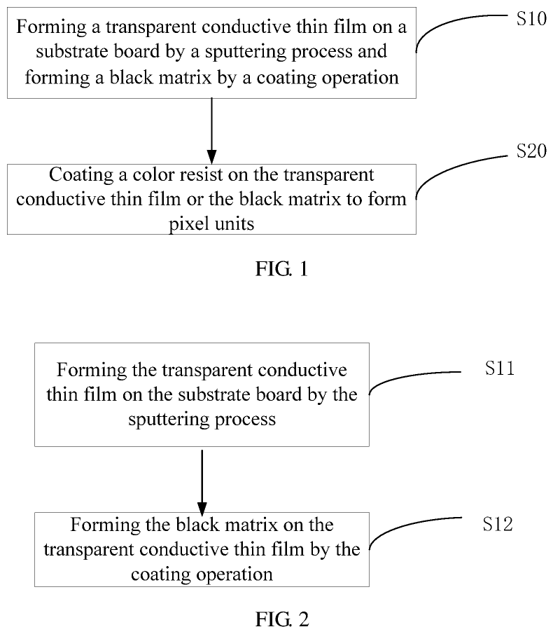

Referring to FIG. 1, the present disclosure provides a preparation process of a color film substrate, including the following steps:

Step S10: Forming a transparent conductive thin film 50 layer on a substrate board 10 by a sputtering process and forming a black matrix 20 by a coating operation; and step S20: Coating a color resist 30 on the transparent conductive thin film 50 or the black matrix 20 to form pixel units.

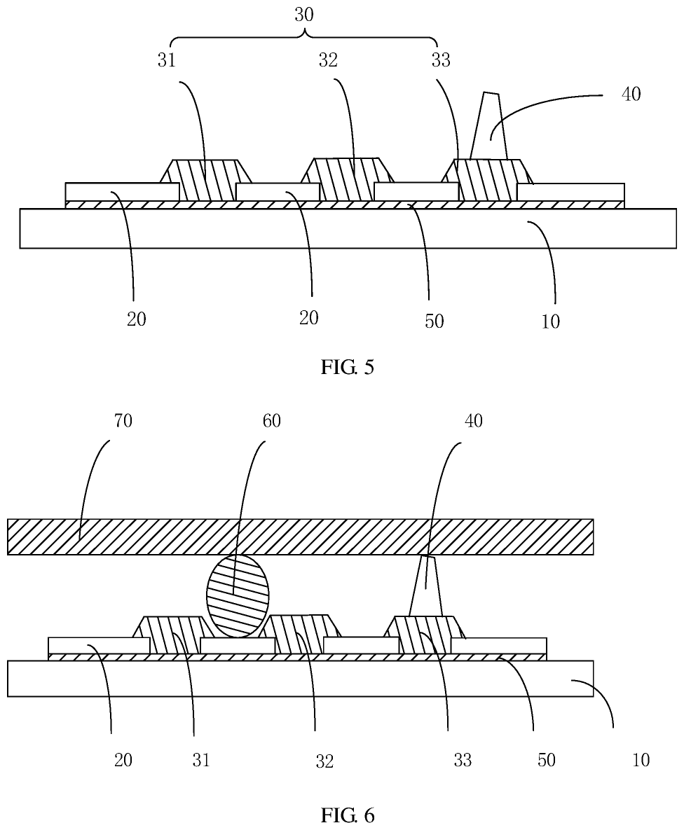

As shown in FIG. 4 and FIG. 5, in the present embodiment, a color resist 30 is located at the outermost layer of a color film substrate, and a transparent conductive thin film 50 is located between a substrate board 10 and the color resist 30, and the transparent conductive thin film 50 is covered on the substrate board 10 or a black matrix 20 by a sputtering process, namely, whether the transparent conductive thin film 50 covers on the substrate board or the black matrix 20, as long as the transparent conductive thin film 50 is located between the substrate board 10 and the color resist 30, there is no influence on the performance of the color film substrate itself.

The transparent conductive thin film 50 is a transparent conductive oxide formed of Indium Tin Oxide (ITO). In the sputtering process of the transparent conductive thin film 50, a thickness of the film may be adjusted through the sputtering process conditions and deposition time. It is necessary to clean the substrate board 10 before sputtering the transparent conductive film 50 on the substrate board 10, so as to avoid dirt on the substrate affecting the uniformity of the thin film coating or causing pollution to the thin film.

As shown in FIG. 5, in the embodiment in which the transparent conductive thin film 50 is located between the substrate board 10 and the black matrix 20, the transparent conductive thin film 50 is directly sputtered on the substrate board 10. As shown in FIG. 2, after the sputtering process of the transparent conductive thin film 50 is completed, the coating process of the black matrix 20 is performed on the transparent conductive thin film 50, so that one side of the transparent conductive thin film 50 that deviates from the substrate board 10 is covered with the black matrix 20 coating. While one of the main functions of the black matrix 20 in the color film substrate is to prevent color mixing between the primary colors in the color resist 30, thereby improving color purity of displayed images. Therefore, as shown in FIG. 4 and FIG. 5, the color resist 30 is not allowed to completely overlap with the black matrix 20, which requires removing part of the black matrix 20 coating to coat the color resist 30.

In the preparation process of the color film substrate, the undesired black matrix 20 coating is removed by photolithography and development processes according to negative photoresist property of the black matrix 20 material. Desired portion of the black matrix 20 that needs to be reserved is irradiated by ultraviolet light in the photolithography process, and the unirradiated black matrix 20 material is removed by alkaline developing solution in the development process, leaving the irradiated portion to form the black matrix 20 pattern.

The color resist 30 is coated on the black matrix 20 pattern. In the present embodiment, the color resist 30 include color resists 30 of three primary colors of red, green, and blue, and the color resists 30 of the three primary colors are sequentially arranged (the order of the array is not limited, as long as the three primary colors of red, green, and blue are included in any three adjacent color resists 30). While there is the black matrix 20 coating between any two of the adjacent color resists 30 to prevent color mixing between the primary colors from affecting the display effect. The coating of the color resist 30 is sequentially performed, and the order may be determined according to requirements, and there is no limitation in the order. Taking firstly coating a red color resist 31 as an example, coating of the red color resist 31 is directly coated on the black matrix 20 pattern that formed after the photolithography and development processes, and undesired red color resist coating is removed by the photolithography and development processes to form the red color resist 31. At this time, the color film substrate already has two patterns of the black matrix 20 and the red color resist 31. Then a green color resist 32 coating is coated on the color film substrate, and undesired green color resist coating is removed by the photolithography and development processes, leaving the desired portion to form the green color resist 32. Finally, a blue color resist 33 coating is coated, then a blue color resist 33 is formed by the photolithography and development processes. At this point, the processes of the color resist 30 of the color film substrate are completed.

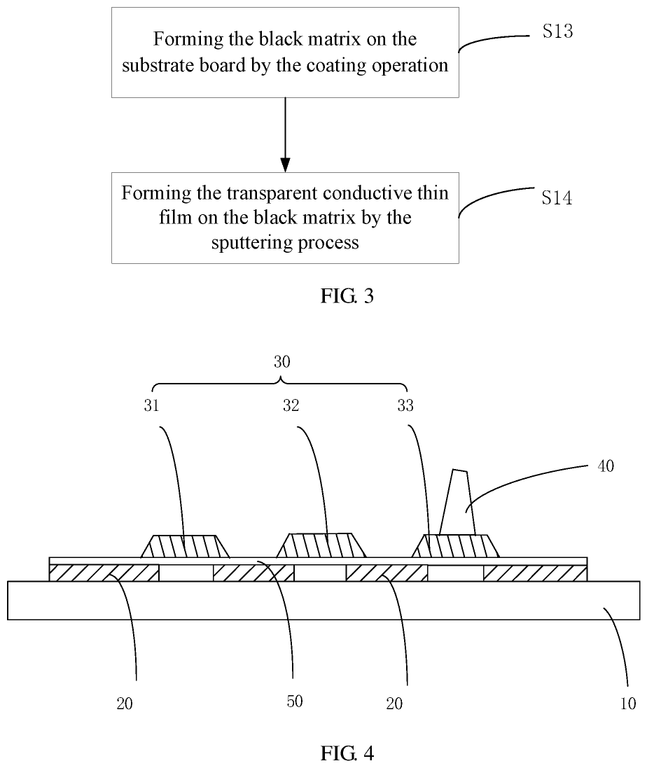

As shown in FIG. 3 and FIG. 4, in the embodiment in which the transparent conductive thin film 50 is located between the black matrix 20 and the color resist 30, the black matrix coating is coated on the substrate board 10, and the black matrix 20 pattern is formed after the lithography and development processes. Then a sputtering process of the transparent conductive thin film 50 is performed on the black matrix 20 pattern to form the transparent conductive thin film 50 on the black matrix 20 pattern. The color resist 30 is coated on the transparent conductive thin film 50. Taking the color resists of the three primary colors of red, green and blue as an example, firstly a red color resist coating is coated on the transparent conductive thin film 50, then undesired red color resist material is removed by the photolithography and development processes to form the red color resist 30. Then the coating, photolithography, and development processes of the green color resist 32 are performed to form the green color resist 32, finally proceeding to the processes of the blue color resist 33.

Since the color resist 30 is at the outermost layer of the color film substrate, the moisture which is not completely released during the preparation process of the color resist 30 remains in the color resist 30, or, the color resist 30 may also absorb a certain amount of moisture from the air during the storage process after the production of the color film substrate. The transparent conductive thin film 50 is located between the substrate board 10 and the color resist 30, so that the color film substrate may freely release moisture therein in a subsequent thermal process, without being obstructed by the transparent conductive thin film 50. Therefore, bubbles formed by the moisture won't appear in the finished product of the color film substrate. When the color film substrate is applied to the display device, no bubble points will appear to affect the display effect on the display device.

The present disclosure further provides a color film substrate, which is prepared by any one of the preparation processes of the color film substrates as described above, and the color film substrate is located on a light emitting side of a liquid crystal layer in a display device. The color film substrate includes: a substrate board 10, a transparent conductive thin film 50, and a color resist 30. The transparent conductive thin film 50 and the color resist 30 are disposed on the substrate board 10, and the transparent conductive thin film 50 is located between the substrate board 10 and the color resist 30, and the transparent conductive thin film 50 at least covers a region enclosed by the color resist 30.

In the present embodiment, the transparent conductive thin film 50 is a whole thin film, and at least covers the area enclosed by the color resist 30. When the color film substrate is applied to a display device, the transparent conductive thin film 50 is mainly used as a common electrode, and cooperates with an electrode on the other side of a liquid crystal to deflect the liquid crystal. Therefore, the transparent conductive thin film 50 may also cover the entire substrate board 10, which does not affect the performance of the color film substrate.

As shown in FIG. 4 and FIG. 5, the color film substrate further includes a black matrix 20, and the black matrix 20 is coated in two ways, namely, the black matrix 20 is coated between the transparent conductive thin film 50 and the substrate board 10, or coated between the transparent conductive thin film 50 and the color resist 30. The function of the black matrix 20 is to block scattered light of the liquid crystal layer, so that the light passes only through the color resist 30, which prevents color mixing between the primary colors, and prevents the ambient light from illuminating the channel of the thin film transistor, thus affecting of the display effect is avoid. Therefore, there is the black matrix 20 coating between any two of the adjacent color resists 30, and the outermost color resist 30 is also surrounded by the black matrix material, so that the light irradiated to the color resist 30 all comes from the liquid crystal. Edge portions of the color resist 30 may overlap with the black matrix 20, and overlapping portions of the color resist and the black matrix are located above the black matrix to prevent color mixing of the light emitted from the edge position of the color resist 30, namely, the color resist 30 is only necessary to exist in the portion that not covered by the black matrix 20 material, so that the light is allowable to pass through the color resist 30.

Optionally, the color resist 30 includes color resists of three primary colors of red, green, and blue, or the color resist 30 includes color resists of four primary colors of red, green, blue, and yellow, or the color resist 30 includes color resists of four primary colors of red, green, blue and white.

Light cannot pass through the portions having the black matrix coating, and light is filtered by the color resist 30 after passing through the color resist 30, leaving only light of a specific color.

Specifically, the substrate board 10 is transparent and is transmittable to visible light.

Since the color resist 30 is at the outermost layer of the color film substrate, the moisture which is not completely released during the preparation process of the color resist 30 remains in the color resist 30, or, the color resist 30 may also absorb a certain amount of moisture from the air during the storage process after the production of the color film substrate. The transparent conductive thin film 50 is located between the substrate board 10 and the color resist 30, so that the color film substrate may freely release moisture therein in a subsequent thermal process, without being obstructed by the transparent conductive thin film 50. Therefore, bubbles formed by the moisture won't appear in the finished product of the color film substrate.

The present disclosure is further provided with a display device, as shown in FIG. 6, and the display device includes any one of the color film substrates as described above. The display device further includes a liquid crystal 60 and an array substrate 70, and the liquid crystal 60 is located between the array substrate 70 and the color film substrate. Light is transmitted from one side of the array substrate 70 to the color film substrate through the liquid crystal 60, and is transmitted out of the color film substrate through the color resist 30. The color film substrate further includes a spacer 40 disposed on a main body of the color film substrate to support a space for accommodating the liquid crystal.

In the present embodiment, the color film substrate is located on the light emitting side of the liquid crystal layer, and the array substrate 70 is located on the light incident side of the liquid crystal layer. The color film substrate and the array substrate 70 each have a common electrode, respectively, when the two common electrodes are energized, the liquid crystal 60 is deflected under the action of an electric field. When light is transmitted from one side of the array substrate 70 to the color film substrate through the liquid crystal 60, the “light valve” characteristic of the liquid crystal 60 modulates the transmittance change of light passing through the liquid crystal layer. When light is transmitted from the liquid crystal to the color film substrate, light is filtered and split in the color film substrate, and finally enables the display device to display.

The spacer 40 is disposed on the main body of the color film substrate to maintain a gap between the array substrate 70 and the color film substrate, and support a space for accommodating the liquid crystal 60, so that the thickness of the liquid crystal cell is stable.

Since there is no bubble formed by the moisture in the finished product of the color film substrate, no bubble points appear to affect the display effect on the display device, so that the production quality of the display device may be optionally ensured.

The above descriptions are only alternative embodiments of the present disclosure, and is not intended to limit the scope of the disclosure of the present disclosure. All the equivalent structural transformation made by the disclosure specification and the attached drawings under the idea of the disclosure, or directly/indirectly used in other relevant technical fields are included in the patent protection scope of the disclosure.

What is claimed is:

1. A preparation process of a color film substrate, wherein, the preparation process of the color film substrate comprises the following steps:
forming a transparent conductive thin film on a substrate board by a sputtering process and forming a black matrix by a coating operation, and
coating a color resist on the transparent conductive thin film or the black matrix to form pixel units.

2. The preparation process of claim 1, wherein, the step of forming the transparent conductive thin film on the substrate board by the sputtering process and forming the black matrix by the coating operation comprises:
forming the transparent conductive thin film on the substrate board by the sputtering process, and
forming the black matrix on the transparent conductive thin film by the coating operation.

3. The preparation process of claim 1, wherein, the step of forming the transparent conductive thin film on the substrate board by the sputtering process and forming the black matrix by the coating operation comprises:
forming the black matrix on the substrate board by the coating operation, and
forming the transparent conductive thin film on the black matrix by the sputtering process.

4. A color film substrate, wherein, the color film substrate is located on a light emitting side of a liquid crystal layer in a display device, and the color film substrate comprises:
a substrate board, a transparent conductive thin film, and a color resist, the transparent conductive thin film and the color resist being disposed on the substrate board, wherein the transparent conductive thin film is located between the substrate board and the color resist, and the transparent conductive thin film at least covers a region enclosed by the color resist.

5. The color film substrate of claim 4, wherein, the color film substrate further comprises a black matrix, the black matrix being located between the transparent conductive thin film and the color resist, the color resist being coated on the black matrix.

6. The color film substrate of claim 5, wherein, the color resist comprises color resists of three primary colors of red, green and blue.

7. The color film substrate of claim 5, wherein, the color resist comprises color resists of four primary colors of red, green, blue and yellow.

8. The color film substrate of claim 5, wherein, the color resist comprises color resists of four primary colors of red, green, blue and white.

9. The color film substrate of claim 6, wherein, the color resists of the three primary colors of red, green, and blue are sequentially arranged and spaced apart from each other.

10. The color film substrate of claim 4, wherein, the color film substrate further comprises a black matrix located between the transparent conductive thin film and the substrate board, and the color resist is coated on the transparent conductive thin film.

11. The color film substrate of claim 10, wherein, the color resist comprises color resists of three primary colors of red, green, and blue; or the color resist comprises color resists of four primary colors of red, green, blue, and yellow; or the color resist comprises color resists of four primary colors of red, green, blue and white.

12. The color film substrate of claim 11, wherein, the color resists are spaced apart from each other, and the black matrix is coated among the spaced color resists.

13. The color film substrate of claim 12, wherein, edges of the color resist overlap with the black matrix.

14. The color film substrate of claim 13, wherein, overlapping portions of the color resist and the black matrix are located above the black matrix.

15. The color film substrate of claim 4, wherein, the transparent conductive thin film is formed of Indium Tin Oxide.

16. The color film substrate of claim 4, wherein, the outermost color resist is surrounded by the black matrix.

17. The color film substrate of claim 4, wherein, the substrate board is transparent and is transmittable to visible light.

18. A display device, wherein, the display device comprises a color film substrate, the color film substrate being located on a light emitting side of a liquid crystal layer in the display device, the color film substrate comprising:
a substrate board, a transparent conductive thin film, and a color resist, the transparent conductive thin film and the color resist being disposed on the substrate board, wherein the transparent conductive thin film is located between the substrate board and the color resist, and the transparent conductive thin film at least covers a region enclosed by the color resist.

19. The display device of claim 18, wherein, the display device further comprises an array substrate, the liquid crystal being located between the array substrate and the color film substrate, light being transmitted from one side of the array substrate to the color film substrate through the liquid crystal and being transmitted out of the color film substrate through the color resist.

20. The display device of claim 18, wherein, the color film substrate further comprises a spacer, the spacer being disposed on a main body of the color film substrate.
